(19) United States
(12) Patent Application Publication
(10) Pub. No.: US 2023/0076108 A1
(43) Pub. Date: Mar. 9, 2023

(54) Commercial Aeroponic Food Production Technologies

(71) Applicant: Joseph Atias, Great Neck, NY (US)

(72) Inventor: Joseph Atias, Great Neck, NY (US)

(21) Appl. No.: 17/467,305

(22) Filed: Sep. 6, 2021

(51) Int. Cl. A01G 31/06

(52) U.S. Cl. CPC A01G 31/06; A01G 2031/006

(57) ABSTRACT

The present invention relates to an assembly with multiple layers allowing a closed loop automated process of growing plants in the air with assistance of a nutrient rich mist environment. The proposed method doesn’t require soil or aggregate medium. The proposed method allows vertical growth with small land footprint requirement. It further allows to grow any type of plant all the year around.

### BACKGROUND

### Field of the Invention

The present disclosure is related to a method and apparatus for growing plants. More specifically, the present application is related to an advance method and apparatus allowing multiple plants to grow in a nutrient rich mist environment with no soil or aggregate medium requirement.

### Description of the Related Art

Sprouts, microgreens, shoots or crests (herein referred to as sprouts) are a food produced by exposing seeds to conditions which cause them to germinate and grow into tiny plants. This has previously been done by exposing seeds to moisture by various methods such as immersion or spray. Seeds which are germinated into edible small plant forms include, but are not limited to, those from alfalfa, clover, mung bean, radish, mustard, broccoli, flax, green peas, sunflower, corn, wheat, soybeans, and others.

Seeds that are used for sprouting purposes are obtained from sources such as farm fields, and stored in places such as agricultural warehouses that may be contaminated with bacteria, fungi, or other organisms that can be harmful to health. For example, farm fields may become impacted with wildlife that carry microbial pathogens such as E. coli O157:H7, and salmonella, which can get spread to crops and ultimately to the seeds. Seeds harvested from such fields, and sprouts germinated from such seeds, may be contaminated (e.g., contaminated by such microbial pathogens).

Plant containers and associated trays having multiple locations in which pots may be retained are used in the horticultural industry for simultaneously holding and transporting multiple plant pots, including pots for flowering and non-flowering plants. All manner of sizes of pots are employed by growers, wholesalers and/or retailers in the growing, distribution and retail display of such plants, including based on the type and/or size of plant contained therein. As such, in practice a multitude of different pots and associated trays are utilized in order to accommodate the varying practices that are used in industry.

WO2004095905 discloses planting pots for use with a multicompartment tray, where the pots and tray having a self-orienting configuration. The pots include angled recesses disposed radially about the bottom portion of the pots which engage with corresponding angled protrusions of the compartment. However, this system only allows for a fixed number of pots and limited configurations.

In addition, various pot configurations have been developed to facilitate that the roots of the plants grown in the pot do not become root bound such as by girding or circling around the inner pot and thus minimize need for disturbance at the time of planting to reduce transplant shock.

JP2003299414A provides a seedling pot is composed of a side wall and a bottom where the bottom is formed in a conical form protruding toward the opening of the side wall and has a number of small holes or a net. There is no disclosure regarding engagement with a production or display tray for positioning such plant pots in any desired orientation.

GB 191227744 discloses a flower pot having an external receptacle in the form of an inverted truncated cone which has on or more perforated tubes that extend upwards toward the upper edge of the receptacle. Although designed specifically for orchids, it is reported that roots growth is promoted when they grow between the aeration surfaces provided by the tubes. As with JP2003299414A, there is no disclosure regarding engagement with a production or display tray for positioning such plant pots in any desired orientation.

With respect to prior art methods wherein the sprouts are grown in trays or containers (e.g., in the ultimate retail container), the trays and containers are typically placed on racks and are typically irrigated for the length of the growth cycle by means of overhead irrigation, or by means of entry points in the bottom of the trays or containers, through which the irrigation water may enter.

There are multiple inventions that have been proposed in prior art regarding bringing an advancement and enhanced utility regarding advancements in sprouting devices. Furthermore, the utilization of these systems in daily life are quite cumbersome and non-effective. Also, the features of these utility system are quite limited. Thus, there is a pronounced need in the art for methods/means for protecting the healthfulness and quality of multiple sprouts, by containing the growth for most of the growth cycle in a sanitary, container where multiple species can be grown. The current invention aims to present an advanced methodology where process of growing plants is simplified with nutrient rich mist environment. Plants have no further requirement of soil or aggregate medium to support their growth.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve devices for an advancement presenting an advance methodology to support growth of plant in nutrient rich mist environment without the use of oil or any other type of aggregate.

It is the object of present invention to provide a vertical farming method where the plants can grow vertical and supports small land footprint.

It is a more particular object of the present invention to provide an improved system a method of growing a vegetative plant and create any climate in a box to grow anything year-round.

It is also the objective of invention to provide a growth pod in an aperture where pumps are not required.

It is an object of the present invention to provide a spice ring where each plant is fed individually so if one plant gets sick you replace it other plants will not get infected

It is another object of the present invention to provide a means for protecting the healthfulness and quality of sprouts from pathogenic and spoilage organisms, by containing the growth for most of the growth cycle in a sanitary, closed, retail-ready container, thereby eliminating the need to irrigate the growing seeds and sprouts

It is a further object of the present invention to provide an assembly which can accommodate multiple types of plants species.

It is also the objective of present invention to reduce system and operating costs involved in the process.

Thus, it is the objective to provide a new and improved form of an advancement in sprouting system. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The present invention is illustrated by example and not limitation in the figures of the accompanying drawings, which, like references, indicate similar elements.

FIG. 1 shows the complete assemble form of 3 layers showing the hooks to support frame, chain for movement and all frames as per preferred embodiments of the invention.

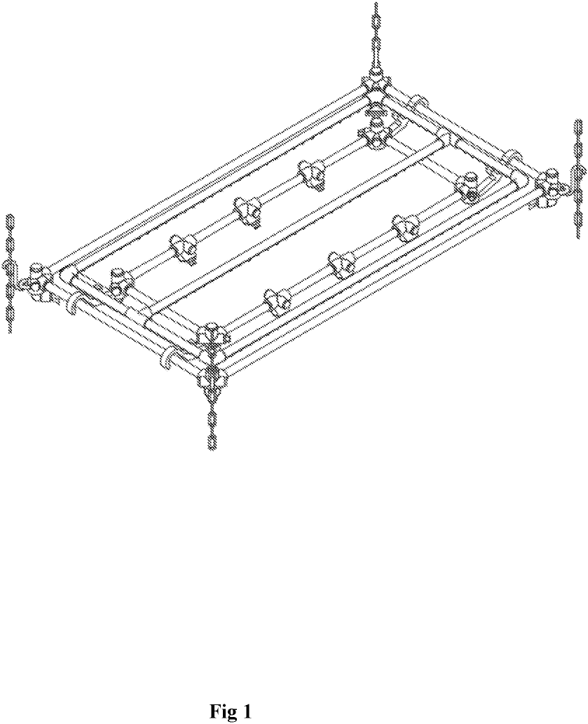

FIG. 2 shows the complete assemble form of middle layer showing the pipes, adaptors and handles as per preferred embodiments of the invention.

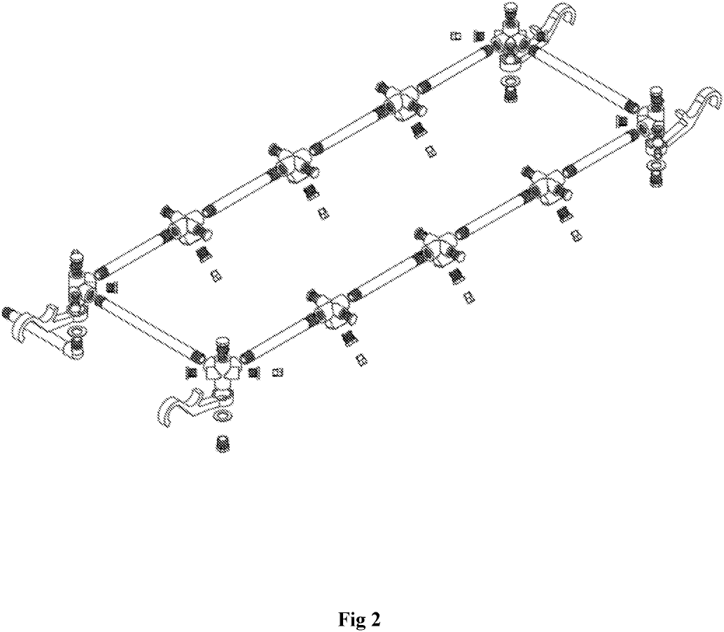

FIG. 3 shows light frame where multiple LEDs are installed as per preferred embodiments of the invention.

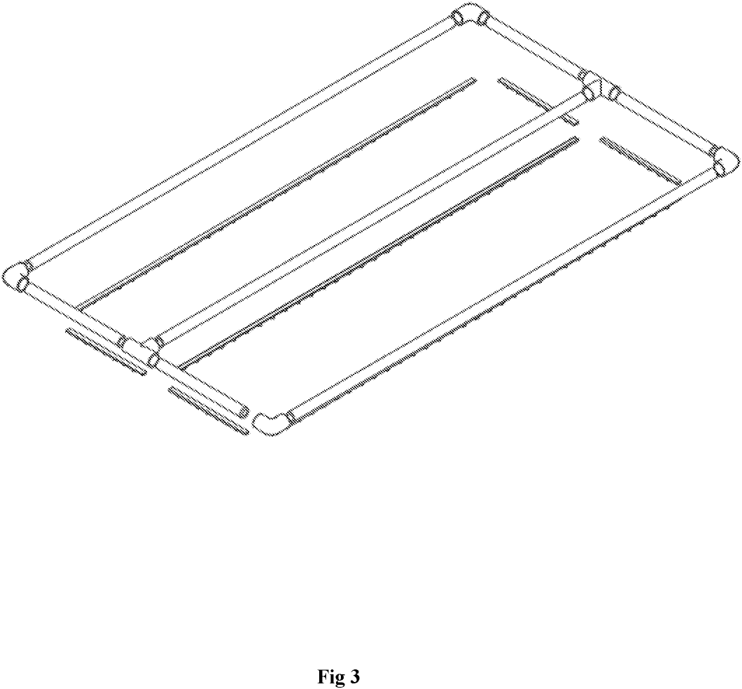

FIG. 4 shows the ventilation and air exchange system which will go through the hollow pipes for effective air circulation as per preferred embodiments of the invention.

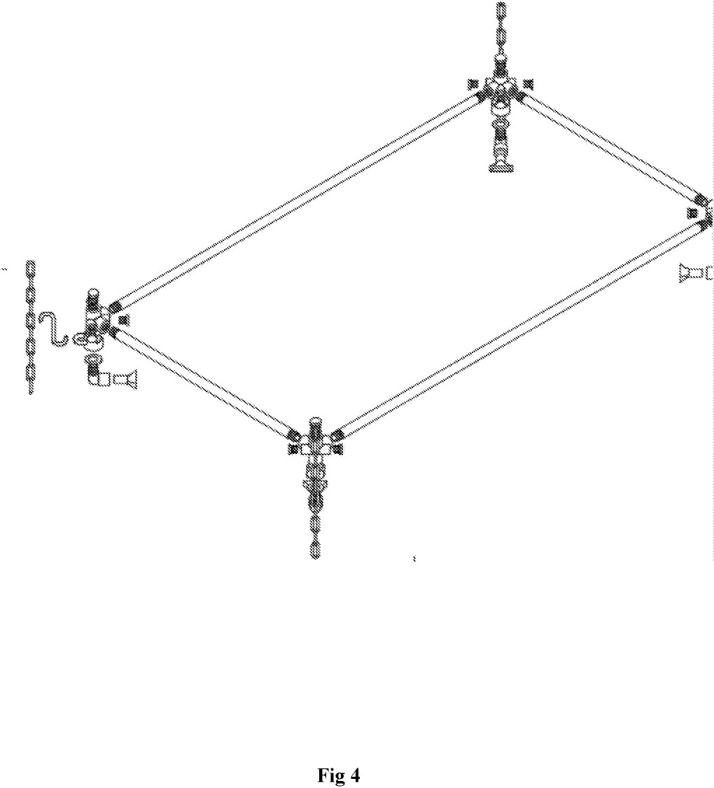

FIG. 5 shows the assembled form of seeder as per preferred embodiments of the invention.

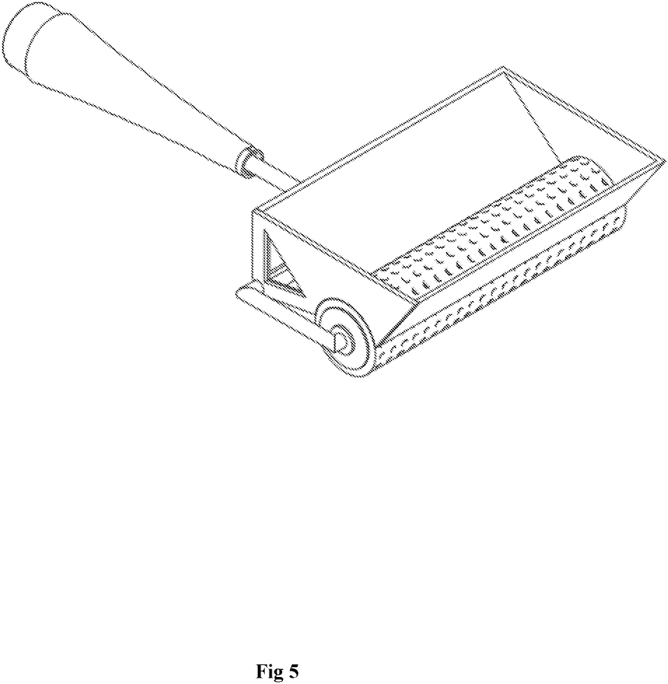

FIG. 6 shows the disassembled form of seeder as per preferred embodiments of the invention.

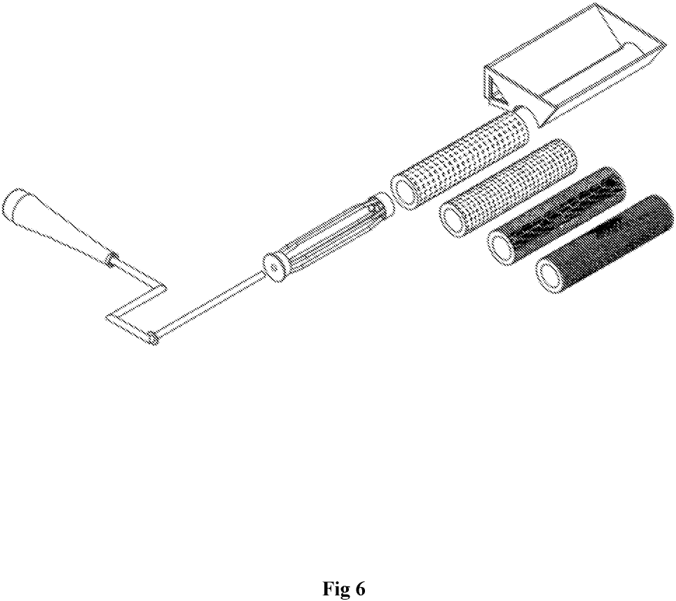

FIG. 7 shows the assembled form in shipping container as per preferred embodiments of the invention.

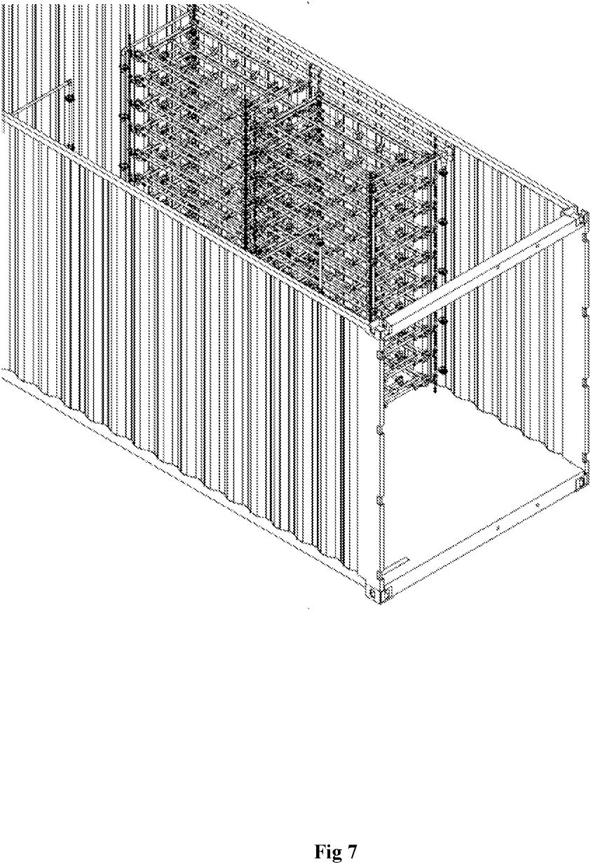

FIG. 8 shows another view of frame showing universal adaptor as per preferred embodiments of the invention.

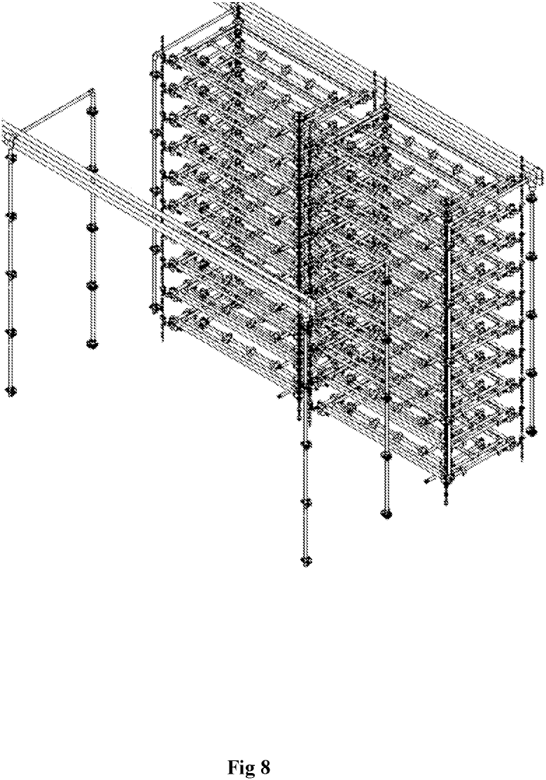

FIG. 9 shows view without frames as per preferred embodiments of the invention.

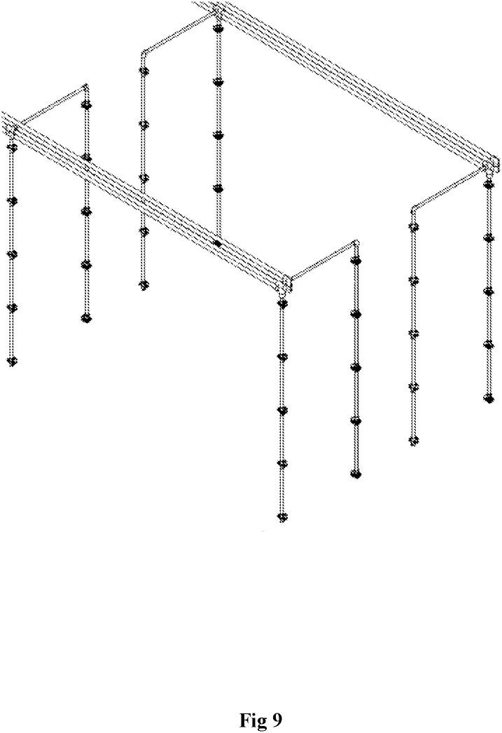

FIG. 10 shows another view without frames as per preferred embodiments of the invention.

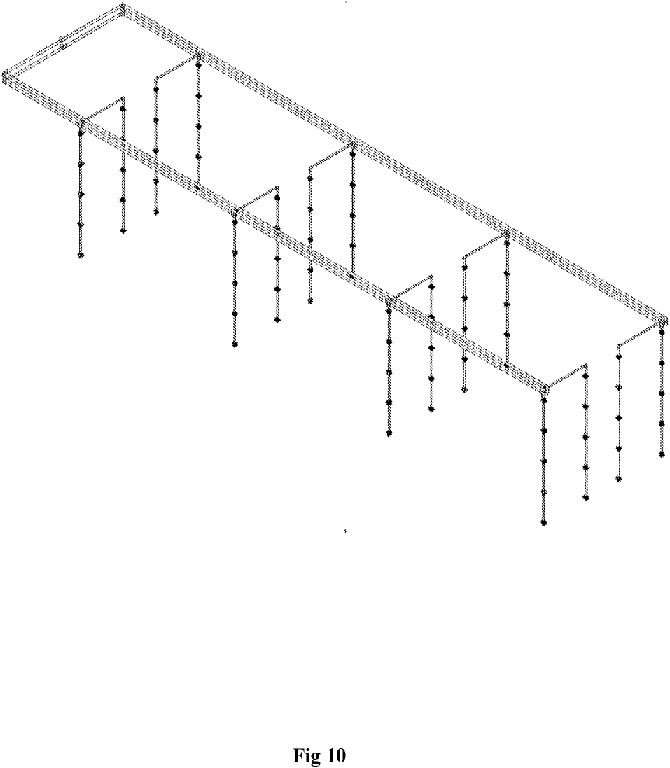

FIG. 11 shows another complete view of frames as per preferred embodiments of the invention.

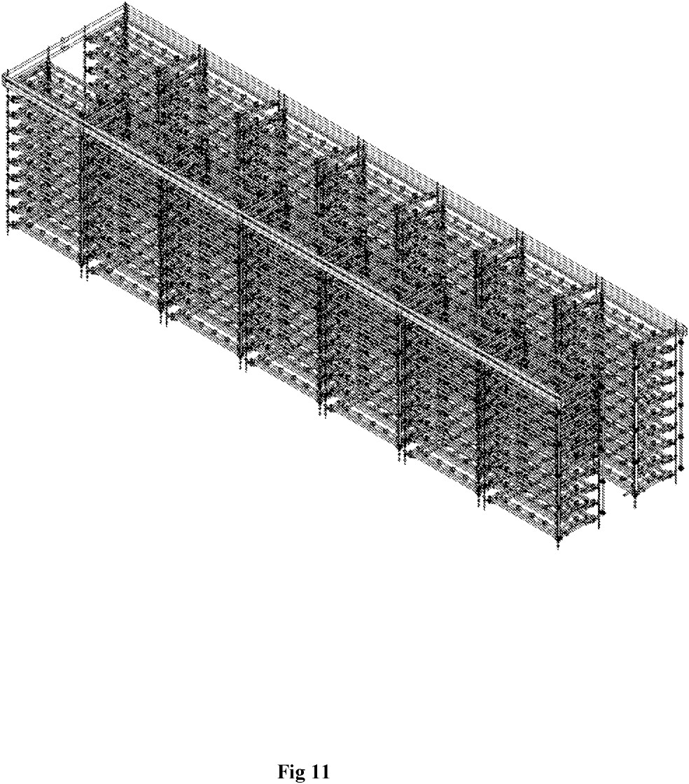

FIG. 12 shows the automatic seeder as per preferred embodiments of the invention.

FIG. 13 shows the automatic harvesting mechanism as per preferred embodiments of the invention.

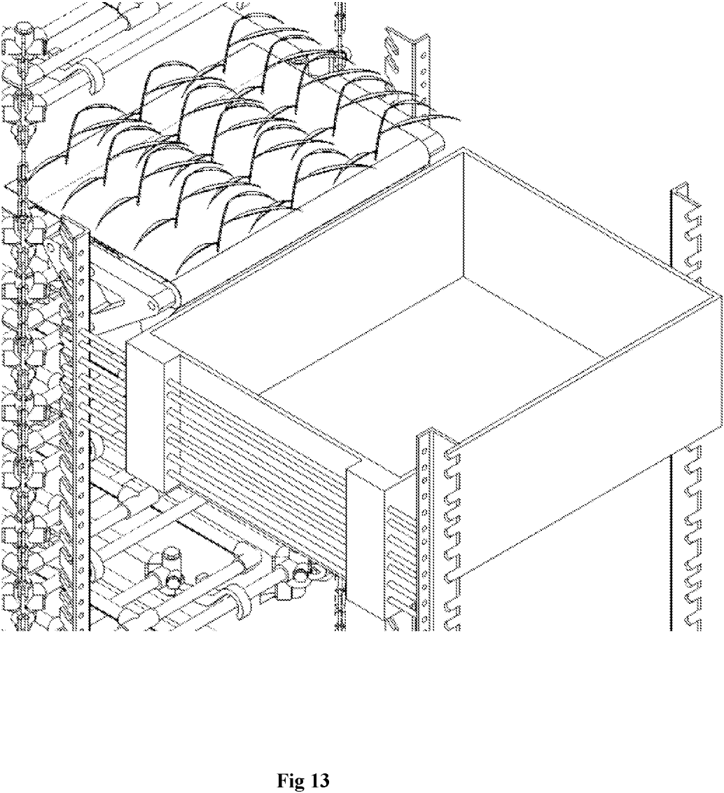

FIG. 14 shows another view of collection of seeds in bin and automatic harvesting mechanism as per preferred embodiments of the invention.

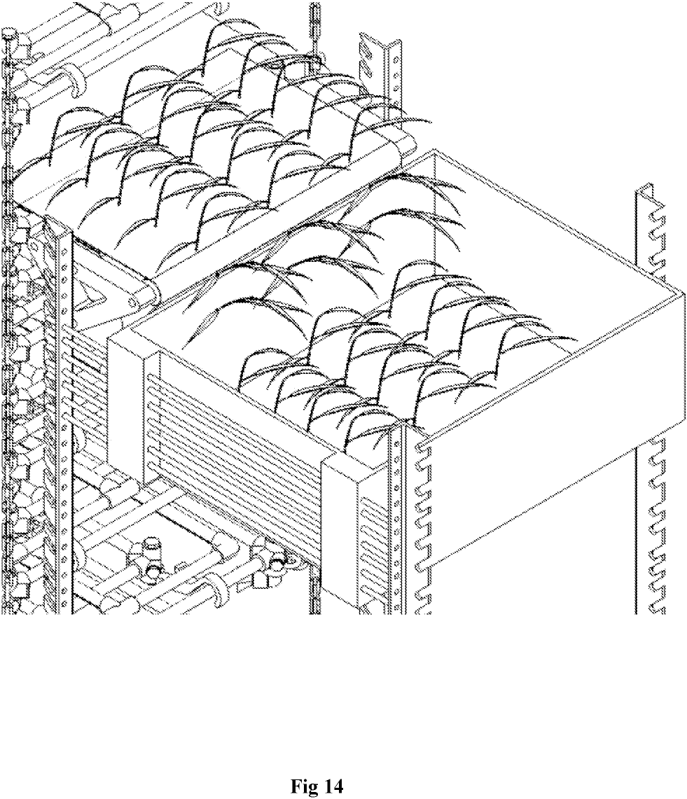

FIG. 15 shows auto-harvesting when the pool back of the grow sheet with the “spikes” that hold the sprouts will open up as the sheet turn on the roll and allow the plant to “free fall” into the collection bin mechanism as per preferred embodiments of the invention.

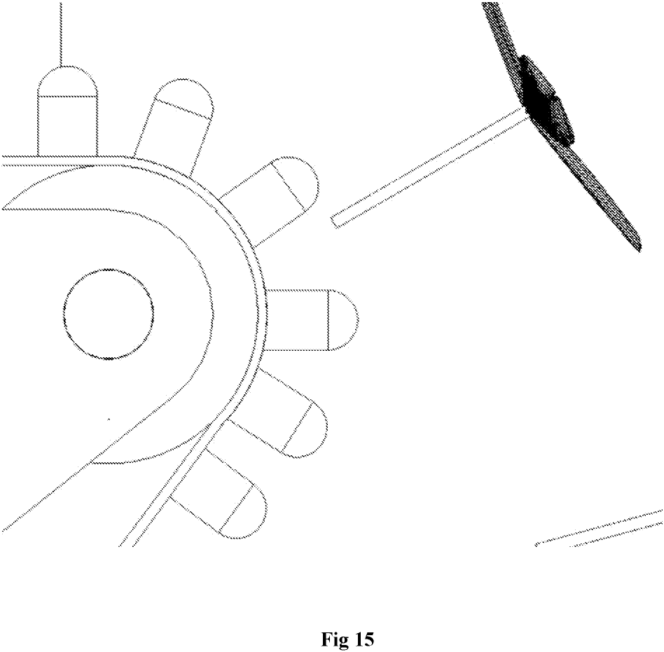

FIG. 16 also shows auto-harvesting when the pool back of the grow sheet with the “spikes” that hold the sprouts will open up as the sheet turn on the roll and allow the plant to “free fall” into the collection bin mechanism as per preferred embodiments of the invention.

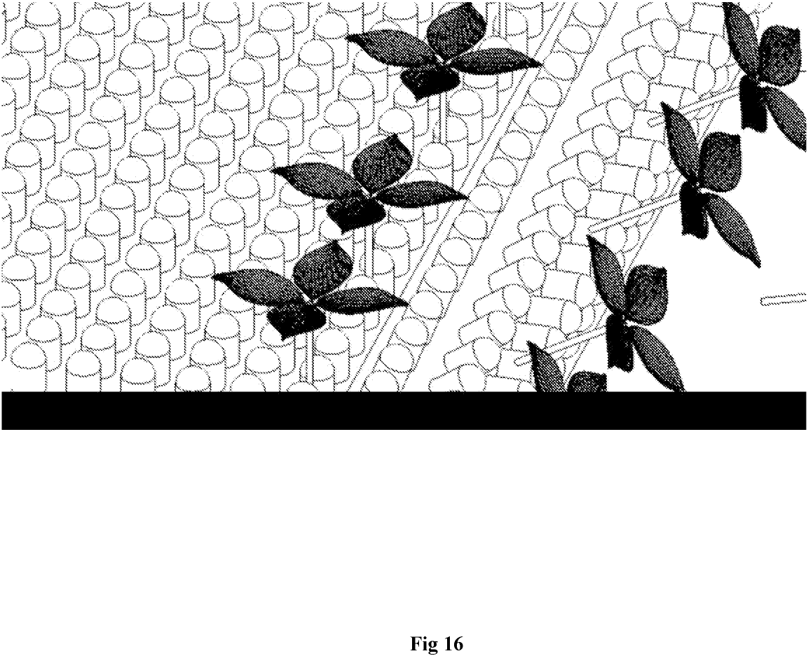

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides an advancement in seeds sprouting device by making use of nutrient rich mist allowing multiple plants to grow without any support of soil or aggregate medium.

As per embodiment of the inventive method for growing sprouts includes a grow light frame, middle is irrigation frame and bottom are airflow frame. All these 3 layers are fully assembled to perform the required functionality.

The middle layer of irrigation frame has PVC pipes where universal adaptors are installed at equally apart places. There are mist sprays installed along adaptors. The handle present at both ends of middle frame allows it to lock to the lower frame. The handles as per further embodiments also allow the top frame to remain intact with complete assembly.

The multi-functional universal adapter has plug, nozzle, air and water distribution system, sensors, connectors and infrastructure support.

There is also an automated seeding and harvesting tool consisting of rollers with holes from 2 mm- 5 mm each. This will go inside the main body and will be affixed there. The seeds will be placed inside the container and when moved forward and backward, seeds will be dispersed equally on soil / Grow mat or other grow medium. The rollers are of various sizes depending on size of seeds.

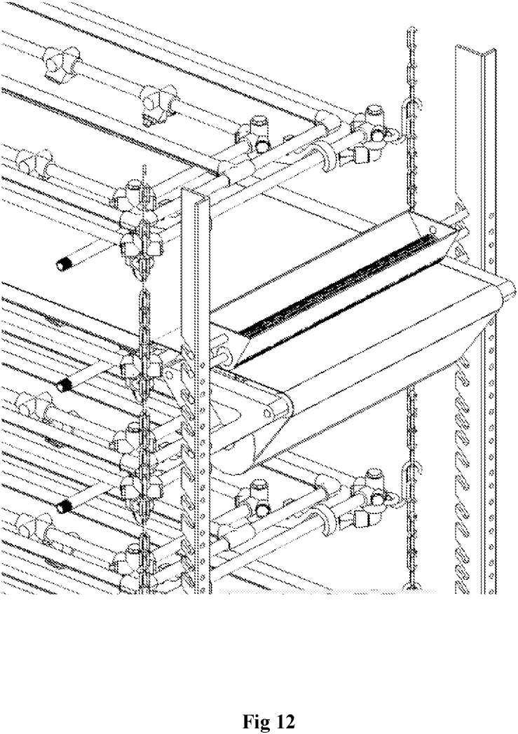

The system as per its further embodiments also provides an automatic harvesting method. This is possible because of Cedar which is shown in FIG. 12. This is the Seder without the wheels, or without the handle, and is sitting exactly at the end or the beginning of the shelving grow. This can be up to 40 ft, which is below the length of the container, but it could be used at any length.

The whole concept of it is where the sheet a special go where no soil is required. As its evident from FIG. 12 roller, Cedar, and complete structure can be seen. The rope pulls the sheet with the little spikes in it. The spikes is like a little comb.

The sheet with the spikes, the Cedar actually is being spin and as its role beneath or underneath the Cedar. Then it’s dispersing the seeds, right and evenly on the sheet and it go all the way to the end or whatever the length is.

The other way to do this is by manual setting. Both the automatic and manual settings allow to save tremendous amount of time. Furthermore, it’s reduces cost and increase efficiency. The seeds are spread evenly to increase them or to give them the best distribution of space between them so they can grow

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A structure for growing plants comprising:
Grow light frame;
middle irrigation frame; and,
bottom airflow frame.
where all 3 layers are fully assembled to perform the required functionality.

2. The middle layer of irrigation frame which has:
PVC pipes;
universal adaptors installed at equally apart places;
mist sprays installed along adaptors; and,
handle present at both ends of middle frame allowing to lock to the lower and upper frame.

3. A seeding tool comprising:
a main body;
multiple rollers with holes from 2 mm- 5 mm each; which will be affixed on main body; and,
seeds will be placed inside the container and when moved forward and backward, seeds will be dispersed equally on soil.

4. An automatic seeding mechanism where:
A harvest to remove seeder where the roll is pulled back when all the plants or micro greens are on the sheet;
Once roll is pulled back, they fall into bin and then will be collected in bag thus resulting in automatic seeding;.

5. A harvest mechanism allowing the technology / process of the spikes on the grow sheet that hold the plants and allow the plants to grow vertically and when its harvest time its rolls back and free fall into collecting bin.
